(19) United States
(12) Patent Application Publication
(10) Pub. No.: US 2017/0289599 A1
(43) Pub. Date: Oct. 5, 2017

(54) LIVE BROADCAST DELAYING METHOD AND APPARATUS

(71) Applicants: Le Holdings(Beijing)Co., Ltd., Beijing (CN); Le Cloud Computing Co., Ltd., Beijing (CN)

(72) Inventors: Maosheng BAI, Beijing (CN); Wei WEI, Beijing (CN); Chi CHEN, Beijing (CN)

(21) Appl. No.: 15/244,874

(22) Filed: Aug. 23, 2016

Related U.S. Application Data
(63) Continuation of application No. PCT/CN2016/088986, filed on Jul. 6, 2016.

(30) Foreign Application Priority Data
Mar. 30, 2016 (CN) 201610195576.7

(51) Int. Cl. H04N 21/262; H04N 21/2187; H04N 21/2365; H04N 21/2387; H04L 29/06

(52) U.S. Cl. CPC H04N 21/2625; H04N 21/2387; H04L 65/601; H04L 65/4084; H04L 65/607; H04N 21/2365; H04N 21/2187

(57) ABSTRACT

The disclosure discloses a live broadcast delaying method and apparatus, the method including: receiving live streaming media transmitted on the spot; segmenting the live streaming media into segmented files at a preset length of time; if a live broadcast delay instruction is received, then obtaining a delay period of time indicated by the live broadcast delay instruction; calculating a play start point of time from the current system time and the delay period of time; searching for one of the segmented files corresponding to the play start point of time, and downloading the segmented file searched to a cloud encoder; encoding the segmented file downloaded in the cloud encoder into delayed live streaming media; and transmitting the delayed live streaming media to a streaming media server, so that the live broadcast can be delayed without any additional costly delay device to thereby lower a cost of delaying the live broadcast.

### CROSS-REFERENCE TO RELATED APPLICATIONS

This application is a continuation of International Application No. PCT/CN2016/088986, filed on Jul. 6, 2016, which is based upon and claims priority to Chinese Patent Application No. 201610195576.7, filed on Mar. 30, 2016, the entire contents of which are incorporated herein by reference.

### TECHNICAL FIELD

The present disclosure relates to the field of video technologies, and particularly to a live broadcast delaying method and apparatus.

### BACKGROUND

As the television (TV) industry is developing rapidly, live broadcasting of TV programs has been popular to respective TV stations and widely applied to the various TV programs. The live TV programs mean real and accurate TV programs broadcasted in real time, and bring a better experience of their users while alleviating a loss of the quality of pictures.

Although the live TV programs mean real TV programs broadcasted in real time, and bring a better experience of their users, they may pose a significant challenge to technical persons. For example, although the safety and stability of related playing devices in a broadcasting room has been greatly improved and guaranteed, an instable factor arising from a personal reason may be inevitable while the programs are being broadcasted, and also may fail to be accordingly adjusted in advance, so the programs may be broadcasted with some adverse social influence. In view of this, such a significant research field has emerged in the TV industry that an unpredictable accident shall be technically avoided from being broadcasted so that the human operators can handle easily the unexpected accident occurring while the live TV programs are being broadcasted, so as to enable the TV programs to be broadcasted in a timely and accurate manner.

Such a secured and simple live broadcast controlling method has been proposed in the prior art that a live broadcast is controlled effectively by delaying the broadcast. Particularly a delay device is added to a broadcast channel, where the delay device operates as follows: a live program is recorded sometime earlier than a predetermined broadcast start point of time, the recorded live program is stored in the delay device, and the live program pre-stored in the delay device is broadcasted at the predetermined broadcast start point of time; and also the delay device continues with recording the live program, thus resulting in a time difference between recording and broadcasting, so that the human operator can control within this time difference an unexpected accident occurring while the TV program is being broadcasted, not to be broadcasted, to thereby handle effectively the unexpected accident. However the delay device is so costly that there may be a high cost of delaying the live TV program.

### SUMMARY

An object of the disclosure is to provide an innovative technical solution to delaying a live broadcast without any costly delay device.

According to a first aspect of the disclosure, there is provided a live broadcast delaying method including:
receiving live streaming media transmitted on the spot;
segmenting the live streaming media into segmented files at a preset length of time;
if a live broadcast delay instruction is received, then:
obtaining a delay period of time indicated by the live broadcast delay instruction;
calculating a play start point of time from the current system time and the delay period of time;
searching for one of the segmented files corresponding to the play start point of time, and downloading the segmented file searched to a cloud encoder;
encoding the segmented file downloaded in the cloud encoder into delayed live streaming media; and
transmitting the delayed live streaming media to a streaming media server.

According to a second aspect of the disclosure, there is provided a live broadcast delaying apparatus including:

at least one processor; and
a memory communicably connected with the at least one processor for storing instructions executable by the at least one processor, wherein execution of the instructions by the at least one processor causes the at least one processor to:
receive live streaming media transmitted on the spot;
segment the live streaming media into segmented files at a preset length of time;
if a live broadcast delay instruction is received, then:
obtain delay period of time indicated by the live broadcast delay instruction;
calculate a play start point of time from the current system time and the delay period of time;
search for one of the segmented files corresponding to the play start point of time, and download the segmented file searched to a cloud encoder;
encode the segmented file downloaded in the cloud encoder into delayed live streaming media; and
transmit the delayed live streaming media to a streaming media server.

According to a third aspect of the disclosure, there is provided A non-transitory computer-readable storage medium storing executable instructions that, when executed by an apparatus, cause the apparatus to:
receive live streaming media transmitted on the spot;
segment the live streaming media into segmented files at a preset length of time;
if a live broadcast delay instruction is received, then:
obtain delay period of time indicated by the live broadcast delay instruction;
calculate a play start point of time from the current system time and the delay period of time;
search for one of the segmented files corresponding to the play start point of time, and download the segmented file searched to a cloud encoder;
encode the segmented file downloaded in the cloud encoder into delayed live streaming media; and
transmit the delayed live streaming media to a streaming media server.

The inventors of the disclosure have identified the problem in the prior art of delaying a live broadcast using a costly delay device. In view of this, a technical task to be attained or a technical problem to be addressed by the disclosure is an innovative technical solution neither conceived nor expected by those skilled in the art.

An advantageous effect of the disclosure lies in that a live broadcast delaying method and apparatus according to the disclosure calculate the play start point of time from the current system time, and the delay period of time indicated by the live broadcast delay instruction, searches for one of the slices of the live streaming media corresponding to the play start point of time, downloads the slice to the cloud encoder for encoding into the delayed live streaming media transmitted to the live streaming media server to thereby enable delaying of the live broadcast without any additional costly delay device so as to lower the cost of delaying the live broadcast.

Exemplary embodiments of the disclosure will be described below in details with reference to the drawings so as to make other features of the disclosure, and their advantages become more apparent.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a live broadcast delaying method in accordance with some embodiments; and

FIG. 2 is a principle block diagram of a structure of a live broadcast delaying apparatus in accordance with some embodiments.

FIG. 3 is a schematic structural diagram of a live broadcast delaying apparatus in accordance with some embodiments.

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

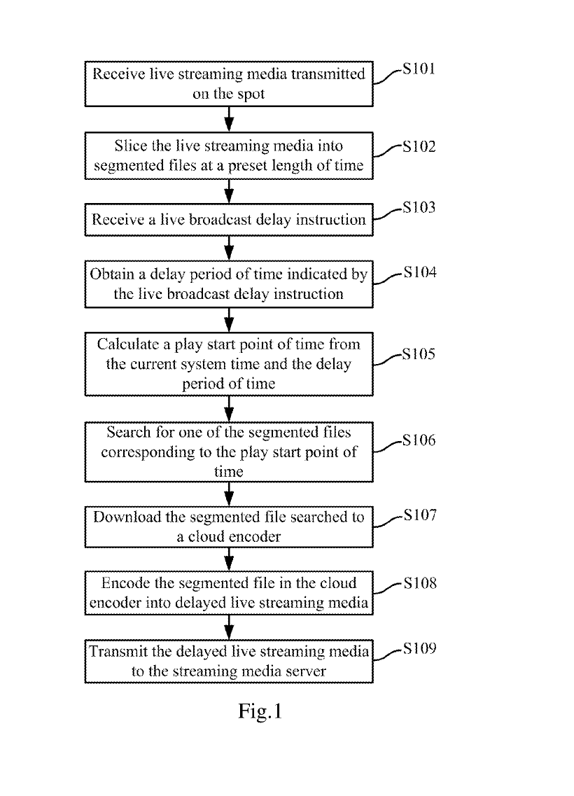

In order to address the problem in the prior art of costly delaying of a live broadcast in a live broadcast delaying using a delayer device, an embodiment of the disclosure provides a live broadcast delaying method as illustrated in FIG. 1 including the following operations:

The operation S101 is to receive live streaming media transmitted on the spot, where a data source recorded on the spot is encoded by a commercial encoder into the live streaming media, and the live streaming media are uploaded to a streaming media server.

Furthermore the streaming media server receives and then stores the live streaming media in a cloud as a video record for subsequent playing on demand.

In a particular embodiment of the disclosure, the streaming media server receives and stores the live streaming media in the cloud, and if the streaming media server receives an instruction to play the live streaming media on demand, then the streaming media server will slice the live streaming media into segmented files, search for one of the segmented files corresponding to a point of time to play the live streaming media on demand, and download the segmented file to a cloud encoder; the cloud encoder will encode the segmented file downloaded into on-demand streaming media, and transmit the on-demand streaming media to the streaming media server; and a playing terminal will retrieve the on-demand streaming media in the streaming media server, and play the contents to be played on demand for a user.

The operation S102 is to slice the live streaming media into segmented files at a preset length of time.

In a particular embodiment of the disclosure, the preset length of time can be one minute, and the streaming media server can receive and then slice the live streaming media into several segmented files at a periodicity of one minute, and furthermore store slice temporal information of the current slices in filenames of the corresponding segmented files. For example, if the streaming media server slices at 14:47 on Mar. 24, 2016, and generates a segmented file, then slice temporal information (e.g., 201603241047) will be included in a filename corresponding to the segmented file.

The operation S103 is that if a live broadcast delay instruction is received, then the operation S103 will proceed to the operation S104; otherwise, no processing will be performed.

The operation S104 is to obtain a delay period of time indicated by the live broadcast delay instruction.

The operation S105 is to calculate a play start point of time from the current system time and the delay period of time.

For example, if the current system time when the live broadcast delay instruction is received is 10:58 on Mar. 24, 2016, and the delay period of time indicated by the live broadcast delay instruction is five minutes, then the delay period of time will be subtracted from the current system time to calculate the play start point of time as 10:53 on Mar. 24, 2016.

The operation S106 is to search for one of the segmented files corresponding to the play start point of time for the purpose of temporal shifting.

For example, if the delay period of time is calculated as 10:53 on Mar. 24, 2016, then the streaming media server will search for a segmented file with a filename including slice temporal information later than the play start point of time, and further retrieve the segmented file with the filename including the slice temporal information later than 201603241053.

The operation S107 is to download the segmented file searched to a cloud encoder.

The operation S108 is to encode the segmented file in the cloud encoder into delayed live streaming media.

Furthermore the segmented file is encoded, where the segmented file with some resolution can be encoded into the delayed live streaming media with any resolution, the segmented file with some bit rate can be encoded into the delayed live streaming media with any bit rate, and the segmented file with some frame rate can be encoded into the delayed live streaming media with any frame rate, so that it may not be necessary to temporally shift all the live streaming media with different configuration parameters of the same data source to thereby greatly simplify the processing flow of delaying a live broadcast.

Taking the resolution as an example, the resolution of the live streaming media is 720P, and the resolution of the corresponding segmented files is also 720P, so the segmented files can be encoded into the delayed live streaming media with a number of resolutions including 360P, 720P, 1080P, etc.

The operation S109 is to transmit the delayed live streaming media to the streaming media server so that the playing terminal can retrieve the delayed live streaming media in the streaming media server, and play the delayed live contents.

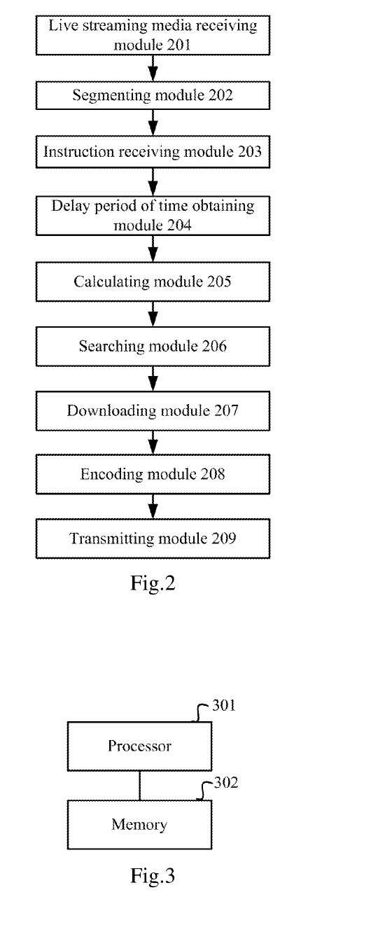

An embodiment of the disclosure provides a live broadcast delaying apparatus on one hand as illustrated in FIG. 2 including a live streaming media receiving module 201, a segmenting module 202, an instruction receiving module 203, a delay period of time obtaining module 204, a calculating module 205, a searching module 206, a downloading module 207, an encoding module 208, and a transmitting module 209, where the live streaming media receiving module 201 is configured to receive live streaming media transmitted on the spot; the segmenting module 202 is configured to slice the live streaming media into segmented files at a preset length of time; the instruction receiving module 203 is configured to receive a live broadcast delay instruction; the delay period of time obtaining module 204 is configured to obtain a delay period of time indicated by the live broadcast delay instruction; the calculating module 205 is configured to calculate a play start point of time from the current system time and the delay period of time; the searching module 206 is configured to search for one of the segmented files corresponding to the play start point of time; the downloading module 207 is configured to download the segmented file searched to a cloud encoder; the encoding module 208 is configured to encode the segmented file downloaded in the cloud encoder into delayed live streaming media; and the transmitting module 209 is configured to transmit the delayed live streaming media to a streaming media server.

Particularly filenames of the segmented files include slice temporal information when the live streaming media are sliced. The searching module 206 is further configured to search based on the play start point of time for a segmented file with a filename including slice temporal information later than the play start point of time.

Furthermore the encoding module 208 is further configured to encode the segmented file generated for the live streaming media with a current configuration parameter into the delayed live streaming media with any configuration parameter, where the configuration parameter includes at least one of a resolution, a bit rate, and a frame rate.

FIG. 3 illustrates a schematic structural diagram of a live broadcast delaying apparatus in accordance with some embodiments, wherein the apparatus includes:
at least one processor 301; and
a memory 302 communicably connected with the at least one processor for storing instructions executable by the at least one processor, wherein execution of the instructions by the at least one processor causes the at least one processor to:
receive live streaming media transmitted on the spot;
segment the live streaming media into segmented files at a preset length of time;
if a live broadcast delay instruction is received, then:
obtain delay period of time indicated by the live broadcast delay instruction;
calculate a play start point of time from the current system time and the delay period of time;
search for one of the segmented files corresponding to the play start point of time, and download the segmented file searched to a cloud encoder;
encode the segmented file downloaded in the cloud encoder into delayed live streaming media; and
transmit the delayed live streaming media to a streaming media server.

wherein filenames of the segmented files comprise slice temporal information when the live streaming media are sliced.

wherein search for one of the segmented files corresponding to the play start point of time includes:
search, based on the play start point of time, for a segmented file with a filename comprising slice temporal information later than the play start point of time.

wherein the at least one processor is further caused to:
after the live streaming media transmitted on the spot is received, store the live streaming media received in a cloud for playback on demand.

wherein encode the segmented file includes:
encode the segmented file generated for the live streaming media with a current configuration parameter into the delayed live streaming media with any configuration parameter, wherein the configuration parameter comprises at least one of a resolution, a bit rate, and a frame rate.

An embodiment of the invention disclosure provides a non-transitory computer-readable storage medium storing executable instructions that, when executed by an electronic device with a touch-sensitive display, cause the electronic device to:
receive live streaming media transmitted on the spot;
segment the live streaming media into segmented files at a preset length of time;
if a live broadcast delay instruction is received, then:
obtain delay period of time indicated by the live broadcast delay instruction;
calculate a play start point of time from the current system time and the delay period of time;
search for one of the segmented files corresponding to the play start point of time, and download the segmented file searched to a cloud encoder;
encode the segmented file downloaded in the cloud encoder into delayed live streaming media; and
transmit the delayed live streaming media to a streaming media server.

wherein filenames of the segmented files comprise slice temporal information when the live streaming media are sliced.

wherein search for one of the segmented files corresponding to the play start point of time includes:
Search, based on the play start point of time, for a segmented file with a filename comprising slice temporal information later than the play start point of time.

The non-transitory computer-readable storage medium further cause the apparatus to:
after the live streaming media transmitted on the spot is received, store the live streaming media received in a cloud for playback on demand.

wherein encode the segmented file includes:
encode the segmented file generated for the live streaming media with a current configuration parameter into the delayed live streaming media with any configuration parameter, wherein the configuration parameter comprises at least one of a resolution, a bit rate, and a frame rate.

Moreover the apparatus can further include an interface device, a communication device, an input device, etc. For example, the interface device includes a USB interface, an RS232 interface, an RS485 interface, etc. For example, the communication device can communicate in a wired or wirelessly mode. For example, the input device can include a touch screen, a keyboard, etc.

The embodiments of the apparatuses described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure.

Those skilled in the art can clearly appreciate from the foregoing description of the embodiments that the embodiments of the disclosure can be implemented in hardware or in software plus a necessary general hardware platform. Based upon such understanding, the technical solutions above essentially or their parts contributing to the prior art can be embodied in the form of a computer software product which can be stored in a computer readable storage medium, e.g., an ROM/RAM, a magnetic disk, an optical disk, etc., and which includes several instructions to cause a computer device (e.g., a personal computer, a server, a network device, etc.) to perform the method according to the respective embodiments of the disclosure.

Lastly it shall be noted that the embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claims is:

1. A live broadcast delaying method, comprising:
receiving live streaming media transmitted on the spot;
segmenting the live streaming media into segmented files at a preset length of time;
if a live broadcast delay instruction is received, then:
obtaining a delay period of time indicated by the live broadcast delay instruction;
calculating a play start point of time from the current system time and the delay period of time;
searching for one of the segmented files corresponding to the play start point of time, and downloading the segmented file searched to a cloud encoder;
encoding the segmented file downloaded in the cloud encoder into delayed live streaming media; and
transmitting the delayed live streaming media to a streaming media server.

2. The method according to claim 1, wherein filenames of the segmented files comprise slice temporal information when the live streaming media are sliced.

3. The method according to claim 2, wherein the searching for one of the segmented files corresponding to the play start point of time comprises:
searching, based on the play start point of time, for a segmented file with a filename comprising slice temporal information later than the play start point of time.

4. The method according to claim 1, wherein the method further comprises:
after the live streaming media transmitted on the spot is received, storing the live streaming media received in a cloud for playback on demand.

5. The method according to claim 1, wherein encoding the segmented file comprises:
encoding the segmented file generated for the live streaming media with a current configuration parameter into the delayed live streaming media with any configuration parameter, wherein the configuration parameter comprises at least one of a resolution, a bit rate, and a frame rate.

6. A live broadcast delaying apparatus, comprising:
at least one processor; and
a memory communicably connected with the at least one processor for storing instructions executable by the at least one processor, wherein execution of the instructions by the at least one processor causes the at least one processor to:
receive live streaming media transmitted on the spot;
segment the live streaming media into segmented files at a preset length of time;
if a live broadcast delay instruction is received, then:
obtain delay period of time indicated by the live broadcast delay instruction;
calculate a play start point of time from the current system time and the delay period of time;
search for one of the segmented files corresponding to the play start point of time, and download the segmented file searched to a cloud encoder;
encode the segmented file downloaded in the cloud encoder into delayed live streaming media; and
transmit the delayed live streaming media to a streaming media server.

7. A live broadcast delaying apparatus according to claim 6, wherein filenames of the segmented files comprise slice temporal information when the live streaming media are sliced.

8. A live broadcast delaying apparatus according to claim 7, wherein search for one of the segmented files corresponding to the play start point of time comprises:
Search, based on the play start point of time, for a segmented file with a filename comprising slice temporal information later than the play start point of time.

9. A live broadcast delaying apparatus according to claim 6, wherein the at least one processor is further caused to:
after the live streaming media transmitted on the spot is received, store the live streaming media received in a cloud for playback on demand.

10. A live broadcast delaying apparatus according to claim 6, wherein encode the segmented file comprises:
encode the segmented file generated for the live streaming media with a current configuration parameter into the delayed live streaming media with any configuration parameter, wherein the configuration parameter comprises at least one of a resolution, a bit rate, and a frame rate.

11. A non-transitory computer-readable storage medium storing executable instructions that, when executed by an apparatus, cause the apparatus to:
receive live streaming media transmitted on the spot;
segment the live streaming media into segmented files at a preset length of time;
if a live broadcast delay instruction is received, then:
obtain delay period of time indicated by the live broadcast delay instruction;
calculate a play start point of time from the current system time and the delay period of time;
search for one of the segmented files corresponding to the play start point of time, and download the segmented file searched to a cloud encoder;
encode the segmented file downloaded in the cloud encoder into delayed live streaming media; and
transmit the delayed live streaming media to a streaming media server.

12. The non-transitory computer-readable storage medium according to claim 11, wherein filenames of the segmented files comprise slice temporal information when the live streaming media are sliced.

13. The non-transitory computer-readable storage medium according to claim 12, wherein search for one of the segmented files corresponding to the play start point of time comprises:
Search, based on the play start point of time, for a segmented file with a filename comprising slice temporal information later than the play start point of time.

14. The non-transitory computer-readable storage medium according to claim 11, further cause the apparatus to:
after the live streaming media transmitted on the spot is received, store the live streaming media received in a cloud for playback on demand.

15. The non-transitory computer-readable storage medium according to claim 11, wherein encode the segmented file comprises:
encode the segmented file generated for the live streaming media with a current configuration parameter into the delayed live streaming media with any configuration parameter, wherein the configuration parameter comprises at least one of a resolution, a bit rate, and a frame rate.
